(19) United States
(12) Patent Application Publication
(10) Pub. No.: US 2018/0150462 A1
(43) Pub. Date: May 31, 2018

(54) MEDIA CONTENT SELECTION

(71) Applicant: Hewlett-Packard Development Company, L.P., Houston, TX (US)

(72) Inventor: David H Hanes, Loveland, CO (US)

(21) Appl. No.: 15/567,600

(22) PCT Filed: May 22, 2015
(86) PCT No.: PCT/US2015/032280

§ 371 Date: Oct. 18, 2017

(51) Int. Cl. G06F 17/30

(52) U.S. Cl. CPC G06F 17/30035; G06F 17/30044; G06F 17/30041; G06F 17/30867

(57) ABSTRACT

According to an example of selecting media content, user profile metadata, location data, and calendar data for a first user is fetched and a repository of available media content is accessed. Content from the repository of available media content to suggest to the first user is determined based on a usage pattern of the first user. In an example, the usage pattern may be based on the user profile metadata, the location data, and an event in the calendar data for the first user. In another example, content from a repository of available media content may be suggested based on a determined usage pattern including historical user location data and the historical user event data from a user calendar, a current time, and a current location.

### BACKGROUND

Electronic devices in the consumer, commercial, and industrial sectors may store or access media content, such as audio or video files, on local or remote sources. Users of such devices may accumulate large libraries of files locally over time, and may have access to even larger libraries of files stored on remote sources. Users may choose to access files from various locations such as at home, at work, or on the road, or within certain areas of a location, such as from a particular room in a house or office setting.

### BRIEF DESCRIPTION OF THE DRAWINGS

FIG. 1 illustrates a media content ecosystem including user devices, according to an example of the present disclosure;

FIG. 2 illustrates a flowchart for selecting media content, according to an example of the present disclosure; and

FIG. 3 illustrates a schematic representation of a computing device that may be used as a platform for selecting media content, according to an example of the present disclosure.

### DETAILED DESCRIPTION

Various examples described below provide for selecting media content for a user, by automatically transmitting, sending, or delivering the content to a user, or by providing the user with a recommendation or suggestion through which the user can then select media content. In some examples, the content may be selected or recommended based on contextual information, such as current or historical data related to a user's location, which may include location data on a room-by-room basis and/or from a wearable device. In other examples, the content may be selected or recommended based on current or historical data related to calendar event data, such as events scheduled or attended by a user, or based on holiday or vacation dates.

In some examples, current and/or historical data may be used to determine usage patterns for a user, which may be used to determine which content to select or recommend. In some examples, data of multiple users may be used to determine which content to select or recommend, alone or in combination with conflict resolution rules if multiple users are in the same location.

In general, users of electronic devices such as desktop computers, laptop computers, tablets, mobile devices, monitors, displays, and other devices (hereinafter “device” or “devices”) may seek to play media content on the devices, or through separate audio or video devices connected to the devices. For example, a device may be a network-connected radio, amplifier, or speaker that is able to play back media content from local or remote sources such as a local library of stored audio files or a streaming radio service. In another example, a device may be a network-connected TV with access to a local library of stored video files or a streaming video service.

Media content may be music files, video files, or combinations of the two in the form of multimedia files. For example, media content may be an MP3 audio file, an MPEG video file, or a presentation file incorporating audio and video.

A user of an electronic device may have hundreds or thousands of content files stored locally, such as in a music library or a video library. Moreover, a user may also have access to even more content stored on remote services, such as streaming radio services and/or streaming video services. In such examples, managing content and choosing content to play at any given time may be cumbersome and time-consuming.

However, such devices may have access to contextual information about the device or the user. For example, contextual information may include information about the location of the device or the user, which may be obtained from a wearable device, GPS, Wi-Fi, IP address lookup, or other technique, and which may be accurate to the level of a state, city, street, home or office, or even a particular room in a home or office.

The device may also have access to contextual information about the user or device in the form of access to a calendar, holiday, or event data, such as the personal calendar of a user of the device. In such examples, the device may have access to event types, event locations, event durations, geo-fencing data, and other information stored in the calendar.

In some examples, the device itself may not have access to the contextual information discussed above, but such information may be stored or accessed by another device, server, or service. In some examples, the device, server, or service may also have access to historical information, such as historical playback data, historical contextual information, or combinations thereof. For example, such data may indicate that a repeating Friday evening calendar event for a dinner reservation usually results in the user tuning a smooth jazz streaming radio station for a duration of 90 minutes once the user, or a wearable device associated with the user, enters a dining room in the user's home.

In some examples, other contextual information about the user may be detected from a wearable device, such as a pulse, running pace, biometric data, health data, or other data related to the user's body.

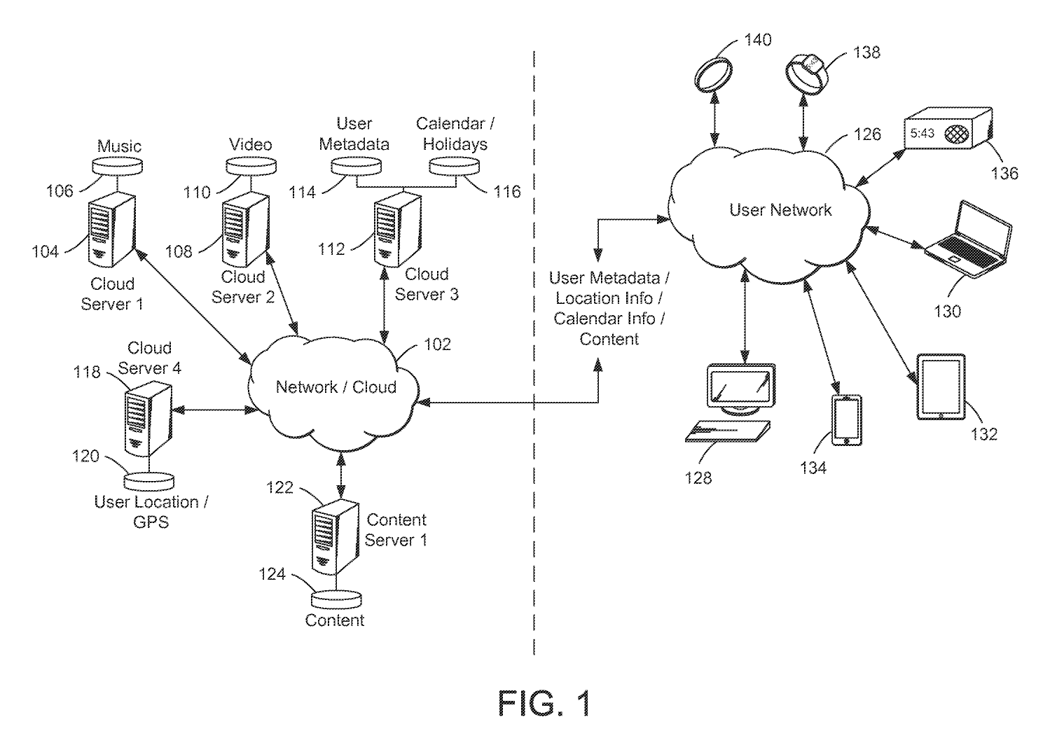

FIG. 1 illustrates a media content ecosystem including user devices, according to an example of the present disclosure. A user device may be a desktop 128, laptop 130, tablet 132, mobile device 134, or network-connected audio device or radio 136. A user device may also be a wearable device, such as a watch 138 or a wristband 140. In some examples, the devices, such as radio 136 may include a built-in speaker, while in other examples, the devices such as radio 136 may have an analog out port or digital out port for connecting radio 136 to a speaker.

Any of devices 128-140 may connect directly to a network such as the internet, or through a local network such as a user network 126. Devices 128-140 may also store media content locally, or may access each other for content, or may access remote sources of content as discussed below. Any of devices 128-140 may also store, generate, or access contextual information about either the user or the device, such as the location-based or calendar-based data discussed above, as well as other data or metadata including, for example, user identifiers, current or local dates and times, and other data.

In an example, devices 128-140 may connect to a local or remote server or service, as shown in FIG. 1. For example, devices 128-140 may connect to cloud server 104, which may store music in a database 106 or other storage or file system, which may be sent to devices 128-140 as, for example, MP3 files. Similarly, devices 128-140 may connect to cloud server 108, which may store video in a database 110 or other storage or file system, which may be sent to devices 128-140 as, for example, MPEG files. Content server 122 may store other types of content, such as presentation files or other multimedia content, which may be sent to devices 128-140.

Devices 128-140 may also connect to cloud server 112, which may generate, store, receive, or access metadata related to the user in, e.g., database 114, or other contextual information about the user such as calendar, event, or holiday data, e.g., in database 116. Cloud server 112 may also generate, store, receive, or access metadata or data related to the devices 128-140, including data collected from wearable devices. Data stored on cloud server 112 may be both current and historical data, such as user preferences or playback data associated with particular events, times, locations, or other contextual data.

Devices 128-140 may also connect to cloud server 118, which may store, receive, or access data related to the location of a user or device. As discussed above, location data may be obtained from a wearable device, GPS, Wi-Fi, IP address lookup, or other technique, and may be accurate to the level of a state, city, street, home or office, or even a particular room in a home or office.

Servers 104, 108, 112, 118, and 122 may connect via a public or private network, such as network or cloud 102 or the internet, and may communicate directly with devices 128-140 or through a user network 126. Any of the content or data generated, stored, accessed, collected, or otherwise utilized in the ecosystem of FIG. 1 may be stored locally or remotely, such as in local libraries on a user device or libraries on a server or service.

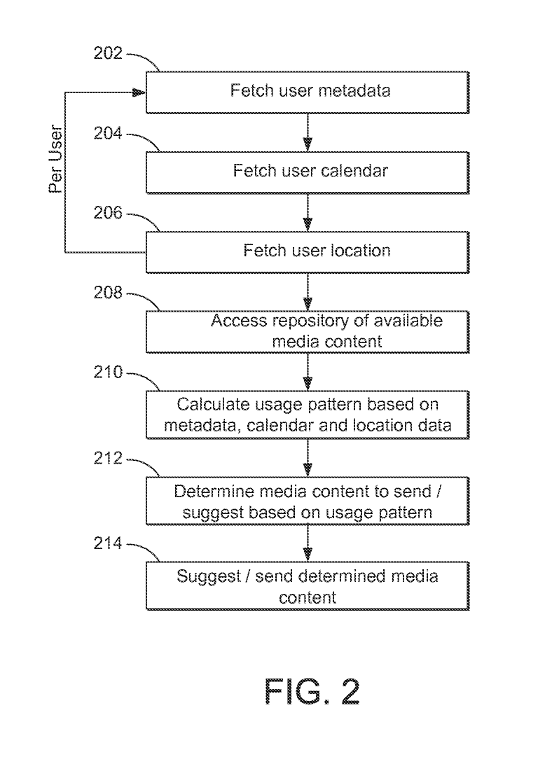

FIG. 2 illustrates a flowchart for selecting media content, according to an example of the present disclosure.

In the example of FIG. 2, in block 202, user metadata is fetched. User metadata may include, for example, a user identifier, user profile, a device identifier, a user type, a device type, serial numbers, or other data for identifying a user or device. The data may be fetched locally on the device, or by another device, server, or service for selecting media content. In some examples, user metadata may include data related to a wearable device, such as information about the user, the user's body, or other information accessible or detectable by the wearable device.

In block 204, a user calendar or data from a user calendar is fetched. In one example, current data about an upcoming event for a user may be fetched, such as the event date and time, location, event type, or other data. In another example, current data about an upcoming event may be fetched, along with historical information from the user's calendar, such as data related to similar events based on event name, type, or location, or data related to events typically attended by the user at a given time. In some examples, calendar data may also be fetched from a wearable device, which may itself store or access data relating to a user's calendar, events, habits, commute times, or other information.

In some examples, historical calendar information may be fetched from a repository of stored calendar data, as opposed to from the calendar or device itself. Stored calendar data may be processed, grouped, aggregated, or otherwise analyzed.

In block 206, user location or device location data is fetched. As discussed above, location data may be related to the device or the user, which may be obtained from a wearable device, GPS, Wi-Fi, IP address lookup, or other technique, and which may be accurate to the level of a state, city, street, home or office, or even a particular room in a home or office. For example, location data may indicate that the wearer of a digital watch is currently in a living room, or positioned near exercise equipment. In other examples, historical data may be stored or accessed as described above with relation to calendar data, which may indicate that a user carrying a smartphone typically enters a front hallway of a home each weekday evening at 6 PM.

In block 208, a repository or repositories (hereinafter simply “repository”) of available media content is accessed. The repository may be a local library of audio, video, or multimedia files, a remote library of files, or combinations thereof. Accessing the repository may include querying the repository for files which the user is permissioned to access, such as those to which the user has a license, or may include querying for certain file types, such as a network-enabled radio querying for audio files and not video files, or a wearable device querying for media optimized for display on the wearable device, e.g., an LED watch screen.

Blocks 202 through 206 may loop in the event that multiple users are in the same location or using the same device or set of devices.

In block 210, a usage pattern of the user or device may be determined based on the user profile metadata, the location data, and an event in the calendar data for the first user. In an example with one user, historical user profile metadata and location data may indicate a usage pattern of a user wearing a wearable device entering a vehicle each weekday morning around 7 AM and tuning a network-connected radio in a bedroom to a traffic channel shortly before 7 AM each day. In another example, calendar event data may indicate that the user has a dinner scheduled in the living room for 7 PM, and may tune a living room speaker to a smooth jazz station.

In an example with multiple users, e.g., where blocks 202 through 206 have looped, a location fetched from two wearable devices may indicate that two users are in a living room space at a certain time such as 8 PM, while metadata of historical play data may indicate the types of media content historically selected by those users while in the living room at approximately 8 PM.

In block 212, a determination may be made as to which media content to send or suggest to the user based on the usage pattern determined in block 210, such as matching a usage pattern to a genre, playlist, song, artist, album, video, station, or channel. In block 214, the content or suggestion may be sent to the user or users.

In the event that data for multiple users is fetched, e.g., if blocks 202 through 206 loop, rules or policies for conflict resolution may be implemented. For example, if the media selected to be sent or suggested to a first user does not match the media selected to be sent or suggested to a second user that is in proximity to the first user, a rule may indicate that one user has priority over the other over a particular output device, or content may be alternated or rotated between the users. In other examples, location or proximity data from, e.g., a wearable device, may be used to resolve conflicts, or events on calendars may indicate which user's content or suggestion should take priority.

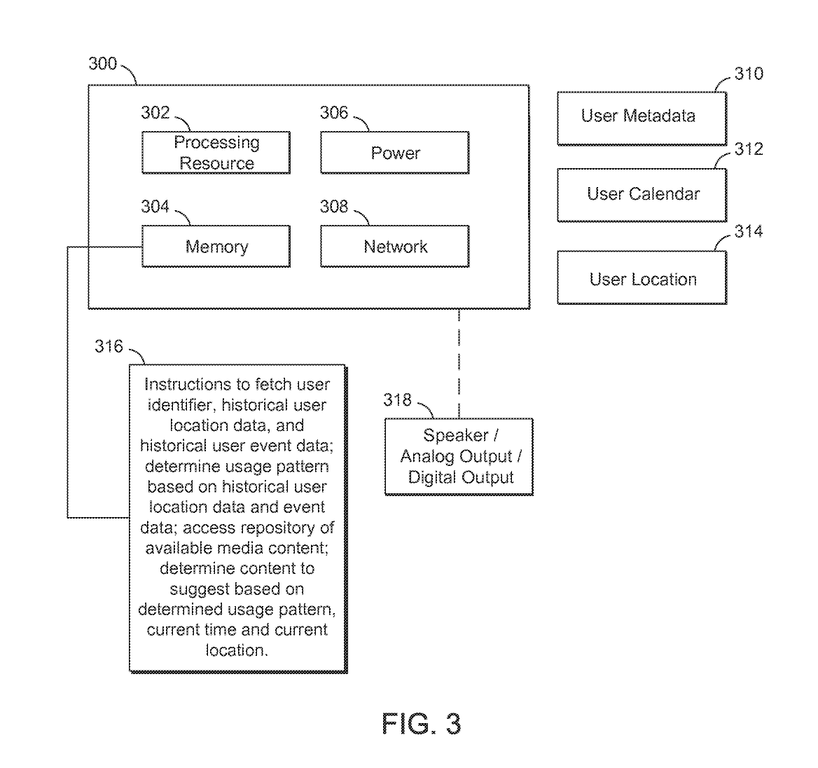

FIG. 3 illustrates a schematic representation of a computing device that may be used as a platform for selecting media content, according to an example of the present disclosure.

In an example, device 300 may be a device such as a network-enabled radio or speaker, or a device with a display and speaker combination. Device 300 may comprise a power source 306, which may be an external, internal, or integrated battery, or other battery capable of supplying power to device 300, or a hard-wired power source such as AC power. In some examples, power source 306 may be a LiION battery.

Device 300 may comprise processing resource 302 such as a processor, CPU, embedded controller, or other processor, and a memory 304, such as a RAM, Flash memory, or other memory storage. Device 300 may also comprise a PMIC or other device capable of communicating with power source 306. Device 300 may also have an output 318, such as a connection to a speaker, display, status lights, or other output. For example, output 318 may be an analog output to a speaker, a digital output to a speaker or display device, or a direct connection to a speaker or display device.

Processor 302 may carry out instructions stored on non-transitory computer-readable storage medium. Each of these components may be operatively coupled to a bus.

Some or all of the operations set forth in the figures may be contained as a utility, program, or subprogram in any desired computer readable storage medium, or embedded on hardware. The computer readable medium may be any suitable medium that participates in providing instructions to the processing resource 302 for execution. For example, the computer readable medium may be non-volatile media, such as an optical or a magnetic disk, or volatile media, such as memory. The computer readable medium may also store other machine-readable instructions, including instructions downloaded from a network or the internet. In addition, the operations may be embodied by machine-readable instructions. For example, they may exist as machine-readable instructions in source code, object code, executable code, or other formats.

Instructions 316 may include, for example, instructions to fetch a user identifier, historical user location data, and historical user event data from a user calendar. The instructions 316 may then determine a usage pattern for the user based on the historical user location data and the historical user event data from the user calendar. Further, the instructions 316 may access a repository of available media content and determine content from the repository of available media content to suggest to the user based the determined usage pattern, a current time, and a current location. In some examples, the instructions may fetch the user identifier, user location data, and user event data from a wearable device.

In some examples, current location data of a device, e.g., a wearable, may be matched to an event in the calendar data of the user to determine what content to suggest or send, and when to do so. For example, a determination may be made that a particular event at a particular time calls for a particular content to be sent or suggested, but only when the wearable device confirms that the user is present or in proximity to the device that will receive the content or suggestion.

In certain examples, some or all of the processes performed herein may be integrated into an operating system. In certain examples, the processes may be at least partially implemented in digital electronic circuitry, in computer hardware, in machine readable instructions, or in any combination thereof.

What is claimed is:

1. A method for selecting media content, comprising:
fetching, with a processor, user profile metadata, location data of a wearable device, and calendar data for a first user;
accessing, with the processor, a digital repository of available media content; and
determining, with the processor, content from the repository of available media content to suggest to the first user based on a usage pattern of the first user,
wherein the usage pattern is based on the user profile metadata, the location data, and an event in the calendar data for the first user.

2. The method according to claim 1, further comprising fetching user profile metadata, location data, and calendar data for a second user and determining content from the repository of available media content to suggest to the first user and the second user based on a combined usage pattern of the first user and the second user.

3. The method according to claim 2, further comprising a rule for resolving a conflict in the usage pattern of the first user and second user.

4. The method according to claim 1, wherein the calendar data includes a scheduled event of the first user.

5. The method according to claim 4, wherein the scheduled event includes a location identifier.

6. The method according to claim 1, wherein the calendar data includes holiday data.

7. The method according to claim 1, wherein the calendar data includes historical play data related to multimedia content.

8. The method according to claim 1, wherein the usage pattern is further based on a match between calendar data and location data.

9. A system for media content selection, comprising:
a processing resource;
a memory; and
an audio output,
wherein the processing resource is to receive profile data, location data, and calendar data for a user and a request from the user to select media content and;
wherein the processing resource is to determine media content to transmit to the audio output based on the user profile data, the location data, and the calendar data.

10. The system of claim 9, wherein the processing resource is to match current location data in the location data to an event in the calendar data.

11. The system of claim 9, further comprising a button to trigger selection of the media content.

12. A non-transitory computer readable storage medium on which is stored a computer program for selecting media content, said computer program comprising a set of instructions to:
fetch a user identifier, historical user location data, and historical user event data from a user calendar;
determine a usage pattern for the user based on the historical user location data and the historical user event data from the user calendar;
access a repository of available media content; and
determine content from the repository of available media content to suggest to the user based on the determined usage pattern, a current time, and a current location.

13. The computer readable storage medium of claim 12, wherein the location data is based on global positioning system data.

14. The computer readable storage medium of claim 12, wherein the location data is based on a Wi-Fi signal.

15. The computer readable storage medium of claim 12, wherein the location data identifies a room within a structure.
